(19) United States
(12) Patent Application Publication
(10) Pub. No.: US 2025/0387835 A1
(43) Pub. Date: Dec. 25, 2025

(54) ADDITIVE MANUFACTURING OF ULTRA-HIGH-TEMPERATURE CERAMICS

(71) Applicant: THE JOHNS HOPKINS UNIVERSITY, Baltimore, MD (US)

(72) Inventors: Adam B. PETERS, Baltimore, MD (US); Dajie ZHANG, Baltimore, MD (US); Dennis NAGLE, Ellicott City, MD (US); James B. SPICER, Baltimore, MD (US)

(21) Appl. No.: 18/847,731

(22) PCT Filed: Jan. 3, 2023
(86) PCT No.: PCT/US2023/010031

§ 371 Date: Sep. 17, 2024

Related U.S. Application Data
(60) Provisional application No. 63/321,203, filed on Mar. 18, 2022.

(51) Int. Cl. B22F 10/62; B22F 1/05; B22F 1/10; B22F 10/10; B28B 1/00; B33Y 10/00; B33Y 40/20; B33Y 70/10

(52) U.S. Cl. CPC B22F 10/62; B22F 1/05; B22F 1/10; B22F 10/10; B28B 1/001; B33Y 10/00; B33Y 40/20; B33Y 70/10; B22F 2301/205; B22F 2304/10; B22F 2998/10; B22F 2999/00

(57) ABSTRACT

A method for additive manufacturing (AM) a carbide body includes producing a feedstock comprising a metallic powder and a binder material. The method also includes laser sintering the feedstock in a laser sintering machine in a presence of an inert gas to produce a green body. The method also includes converting the green body into the carbide body in a furnace in a presence of a flowing alkane gas.

### CROSS-REFERENCE TO RELATED APPLICATIONS

This application is the national stage entry of International Patent Application No. PCT/US2023/010031, filed on Jan. 3, 2023, and published as WO 2023/177463 A3 on Sep. 21, 2023, which claims the benefit of U.S. Provisional Patent Application No. 63/321,203, filed on Mar. 18, 2022, which are hereby incorporated by reference in their entireties.

### GOVERNMENT FUNDING

This invention was made with Government support under grant no. N00014-16-1-2460 awarded by the United States Department of the Navy/Office of Naval Research. The Government has certain rights in the invention.

### FIELD OF THE DISCLOSURE

The present disclosure relates generally to systems and methods for additive manufacturing (AM) of transition metal carbide and ultra-high-temperature ceramics (UHTCs) ceramics. More particularly, the present disclosure relates to systems and methods for AM of UHTC carbides using two carbidization reactions. Selection of processing parameters and precursor constituents allows for tunability of volume change and porosity in the final additively manufactured parts.

### BACKGROUND OF THE DISCLOSURE

Additive manufacturing (AM) is the formalized term for what is popularly known as 3D printing or rapid prototyping. The basic principle of AM is that 3-dimensional parts are produced in a layer-by-layer fashion from a digitally generated model. Over the last several decades, AM has become a highly attractive technique for the fabrication of complex and intricately-shaped components. AM of metals and polymers has progressed to a relatively mature technology, unlike refractory ceramic materials. Non-oxide ceramics (e.g., carbides, nitrides, and borides) have highly desirable properties including high thermal and electrical conductivity as well as resilience to prolonged exposure to high-temperatures, chemically reactive conditions, radiation, stress, and mechanical wear. A subset of these non-oxides, known as ultra-high-temperature ceramics (UHTCs), have the highest melting points of any binary compounds with melting temperatures exceeding 3000° C. and/or thermal and chemical stability in the air above 2000° C. Due to their extreme refractory characteristics, interest in transition metal carbides and UHTC component fabrication has largely been motivated by the unmet materials requirements for aerospace, rocket propulsion, and hypersonic thermal protection systems. UHTC carbides including hafnium carbide (HfC), zirconium carbide (ZrC), tantalum carbide (TaC), and titanium carbide (TiC) have received attention for hypersonic applications such as thermal protection systems, nozzle throats, and control thrusters which require resiliency to the combination of high thermal and mechanical loads, aggressive oxidizing environments, and rapid heating/cooling rates sustained during flights that Mach 5 or atmospheric re-entry. Meanwhile, the application of porous transition metal carbides (e.g. titanium carbide, TiC; tungsten carbide, WC, W₂C, W₃C₂; molybdenum carbide, Mo₂C, Mo₃C₂) may be used for active or electrochemical catalysis due to their high surface to volume ratios and unique materials characteristics.

Processing refractory transition metal carbides and UHTCs into complex geometries using additive manufacturing or traditional ceramics processing techniques is challenging and costly. Ceramics' covalent-ionic and metallic bonds inhibit sufficient atomic mobility to relieve thermally-induced stresses during additive processes and can lead to decomposition when heated to temperatures that produce mobility. This makes both traditional dry powder or colloidal shaping techniques very difficult as high post-processing temperatures and pressure-assisted techniques are needed to produce dense components. Such methodologies often limit geometric complexity to simple axially-symmetric shapes (e.g., cylinders or tiles) or components without internal features. When refractory ceramic compositions are formed through AM, ceramic objects are traditionally obtained through high-temperature consolidation (e.g., sintering) of granular materials through shaping processes that require a binder phase or organic additives (e.g., dispersants, binders, plasticizers, lubricants, etc.) to confer desired rheological and cohesive properties on non-reactive feedstocks. For AM of refractory carbide ceramics, slow atomic diffusion hinders consolidation and sintering of non-oxide particles: high temperatures (e.g., in excess of 2000° C.), slow heating rates (e.g., 0.1-2° C./hr), and high isostatic pressing are necessitated to prevent defects that prevent appreciable mechanical integrity from being obtained.

### SUMMARY

In accordance with an aspect of the present disclosure, a method for additive manufacturing (AM) a carbide body is disclosed. The method includes producing a feedstock comprising a metallic powder and a binder material. The method also includes laser sintering the feedstock in a laser sintering machine in a presence of an inert gas to produce a green body. Laser sintering may be performed using a laser sintering or melting machine used for polymers or metals. The method also includes converting the green body into the carbide body in a furnace in a presence of a flowing alkane gas.

A method for additive manufacturing (AM) an ultra-high-temperature ceramic (UHTC) or transition metal carbide body is also disclosed. The method includes producing a feedstock. The feedstock includes a metallic powder and a binder material. The metallic powder includes from about 60 wt % to about 90 wt % of the feedstock. The metallic powder includes particles having an average diameter ranging from about 10 μm to about 1000 μm. The binder material includes from about 10 wt % to about 75 wt % of the feedstock. The binder material includes a resin. The method also includes laser sintering the feedstock to produce a green body. The feedstock is laser sintered in a laser sintering machine in a presence of an inert gas. The feedstock is laser sintered to above a melting point of the binder material but below a melting point of the metallic powder. The method also includes converting the green body into the UHTC or transition metal carbide body. The conversion comprises an ex-situ isothermal gas-solid conversion. The conversion takes place in a furnace in a presence of a flowing methane. The methane has a flowrate from about 10 SCCM to about 5 L/min. The methane has a composition from about 5 vol % to about 100 vol %. The conversation takes place at a temperature from about 800° C. to about 1100° C. for a duration from about 0.5 hours to about 15 hours. By varying the amount of binder phase and processing conditions (e.g., temperature and/or time) during ex-situ processing volume, changes during conversion to the carbide ceramic and component porosity can be tailored to the desired macro and microstructures. The net dimensional volume change of the part from the conversion of the green body to the final carbide may be from 0 vol % to 80 vol %, where the porosity of the carbide microstructure may be from 0 vol % to 95 vol %.

A method for additive manufacturing (AM) an ultra-high-temperature ceramic (UHTC) body is also disclosed. The method includes producing a feedstock. The feedstock includes a metallic powder and a binder material. The metallic powder includes from about 65 wt % to about 85 wt % of the feedstock. The metallic powder includes a transition metal. The metallic powder includes particles having an average diameter ranging from about 20 μm to about 60 μm. The binder material includes from about 15 wt % to about 35 wt % of the feedstock. The binder material includes a resin. The method also includes laser sintering the feedstock to produce a green body. The feedstock is laser sintered in a laser sintering machine in a presence of 90 vol % to 100 vol % inert gas. The inert gas includes argon, nitrogen, or both. The feedstock is laser sintered with a scan speed from about 1 mm/s to about 10 m/s. The feedstock is laser sintered to above a melting point of the binder material but below a melting point of the metallic powder. The green body includes a plurality of deposited layers of the feedstock. Each deposited layer has a height from about 10 μm to about 250 μm. The method also includes converting the green body into the UHTC body where processing conditions and feedstock composition control the porosity, volume change, and chemical conversion to the product carbide ceramic. The conversion includes an ex-situ isothermal gas-solid conversion. The conversion takes place in a furnace in a presence of a flowing methane. The methane has a flowrate from about 50 SCCM to about 10 L/min. The methane has a composition from about 10 vol % to about 100 vol %. The conversation takes place at a temperature from about 900° C. to about 1000° C. for a duration from about 1 hour to about 10 hours.

### BRIEF DESCRIPTION OF THE FIGURES

FIG. 1 illustrates a schematic view of a system for additive manufacturing (AM) of transition metal carbides and ultra-high-temperature ceramics (UHTCs), according to an embodiment.

FIGS. 2A-2C illustrate digital illustrations of STL files used for printing the target test structures, according to an embodiment.

FIGS. 3A and 3B illustrate green bodies (also referred to as green parts), according to an embodiment.

FIGS. 4A and 4B illustrate the different post-processing reaction schemes, according to an embodiment.

FIGS. 5A-5F illustrate the morphology of the Ti/phenolic lattice and cube, according to an embodiment.

FIGS. 6A and 6B illustrate XRD spectra of the unreacted precursor materials and the green-state sample, according to an embodiment.

FIGS. 7A-7F illustrate XRD results obtained on the converted cube surface and on the cube cross-section, according to an embodiment.

FIG. 8 illustrates a comparison between the cube and lattice samples before and after furnace processing and the volume and porosity changes associated with variation in ex-situ processing parameters, according to an embodiment.

FIGS. 9A-9F illustrate photographs and photomicrographs depicting the SLS processed green Ti+phenolic cube samples before and after CH₄ post-processing to TiCₓ, according to an embodiment.

FIGS. 10A-10D illustrate SEM images of lattice structures, according to an embodiment.

FIGS. 11A and 11B illustrate graphs showing the influence of carbon stoichiometry in TiCₓ on activation energy is required for C diffusion (FIG. 11A) and the temperature-dependent ΔGᵣ associated with Ti reaction with Cₛ or CH₄ (FIG. 11B), according to an embodiment.

FIG. 12A illustrates a photograph from a blow torch test, FIG. 12B illustrates an optical micrograph of the resulting microstructure, FIG. 12C illustrates a photograph of the product lattice, and FIG. 12D illustrates the lattice after heating supporting an 800 g alumina firebrick to illustrate its qualitative mechanical properties, according to an embodiment.

FIG. 13 illustrates a flowchart for a method for AM of UHTCs, according to an embodiment.

### DETAILED DESCRIPTION OF THE PREFERRED EMBODIMENTS

The presently disclosed subject matter now will be described more fully hereinafter with reference to the accompanying Drawings, in which some, but not all embodiments of the disclosures are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

Transition metal carbides, including the ultra-high-temperature ceramic (UHTC), titanium carbide (TiC), may be used as structural materials for applications that are resilient to extreme temperatures (e.g., >2000° C.), high mechanical loads, and/or aggressive oxidizing environments. Standalone materials additive manufacturing (AM) has not been fully realized due to their extremely slow atomic diffusivities that impede sintering and large volume changes during indirect AM that can induce defect structures. In the present disclosure, a two-step in reactive AM approach is described for the formation of the UHTC, TiCₓ. A polymer powder bed fusion AM machine and a tube furnace may be used to produce UHTC cubes and lattice structures with sub-millimeter resolution. This processing scheme incorporates: (1) selective laser sintering of a Ti precursor mixed with a phenolic binder for green body shaping, and (2) ex-situ, isothermal gas-solid conversion of the green body in carbonaceous alkane gas such as methane (CH₄) to form a TiCₓ test shapes. Reactive post-processing in CH₄ resulted in up to 98.2 wt % TiC_{0.90} product yield and a reduction in net-shrinkage during consolidation due to the volume expansion associated with the conversion of Ti to TiC. Results indicated that reaction bonding associated with the Gibbs free energy release upon gas-solid reactivity favorably impacted atomic mobility for interparticle adhesion at low furnace processing temperatures. The ability to bond highly refractory materials through reactivity resulted in structures that were crack-free and resisted fracture during thermal shock testing. Broadly, the AM approach described herein may be viable for the production of many UHTC carbides that might otherwise be incompatible with similar prevailing AM techniques which do not incorporate reaction synthesis.

A polymer powder bed fusion machine may be used to perform at least a portion of an AM processing method that incorporates indirect selective laser sintering of metal precursor materials and conversion to the desired UHTC ceramic during post-processing. Using this process, the chemical conversion and volume changes associated with the production of geometrically complex TiC shapes may be tailored. TiC is an ultra-high temperature material with unique properties: high melting point (3067° C.), high hardness (2800 HV—the most of any carbide), extreme compressive strength (highest of any known material at 36,000 psi), resistance to chemical attack, low coefficients of friction, and high electrical and thermal conductivity. TiC was selected as a model system representative of UHTCs (ZrC, HfC, TaC, Ta₂C, NbC, Nb₂C) and other transition metal carbides (WC, W₂C, W₃C₂ Mo₂C, Mo₃C₂, Fe₃C, Fe₇C₃, Fe₂C, Cr₃C₂, Cr₇C₃, Cr₂₃C₆, VC, V₂C, Co₃C, Co₂C, NiC₃) that might also be produced using this method.

Rather than relying on non-reactive, thermally-driven sintering during high-temperature-post-processing or direct laser (or electron beam melting), reaction synthesis techniques incorporating gas-solid conversion may be used for the conversion of reactive green body precursor materials to the UHTC carbide ceramic. The reaction synthesis approach studied in this work incorporates two distinct steps:
1. Inert selective laser sintering of Ti precursor containing an expendable, low melting temperature organic binder phase (e.g., phenolic resin) that is used to consolidate and shape a green body; and
2. High-temperature, isothermal post-processing of preceramic part that reacts with CH₄ and Cₛ from binder-decomposition-products for UHTC carbide synthesis. In Equation 2 below, ΔV refers to the specific volume change associated with the conversion of the metal to the carbide.

In this approach, two carbidization reactions lead to the formation of TiC:

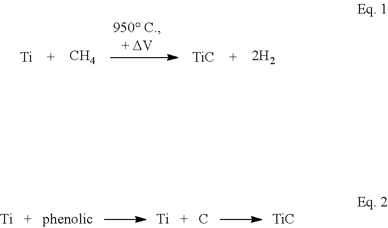

The SLS/reaction synthesis approach utilized here is designed to (1) mitigate shrinkage that may be associated with ceramics post-processing using the volume expansion of Ti to TiC_{1.0} (e.g., ˜14.2 vol %) upon gas-solid conversion; and (2) facilitate interatomic mobility for particle adhesion by leveraging large ΔGᵣ released exothermic, self-propagating reactions. Chemical reactions can facilitate atomic mobility that leads to interparticle bonding in materials systems that are otherwise generally non-sinterable. For a chemical reaction, the change in free energy may be ΔG°≈20,000 J/mol or more, a value significantly greater than the driving force by applied stress or surface area changes alone. For non-oxide materials and UHTCs, with coefficients of diffusion often 10 orders lower than for many refractory oxides, it may be desirable to use this reaction energy to drive interparticle adhesion. If successful, the application of reaction synthesis AM to standalone UHTC or transition metal carbide compositions may be used to construct complex refractory components with tunable porosity and microstructure for thermal protection systems, rocket propulsion, catalysis, or other extreme condition applications.

### Methods

### Experimental Process—SLS of Reactive Precursors Using Powder Bed Fusion Equipment Followed by Reactive Processing.

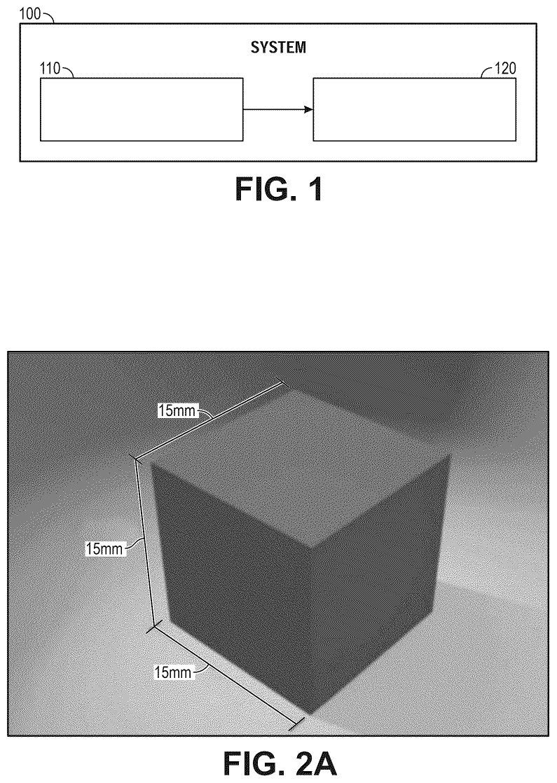

FIG. 1 illustrates a system 100 for AM of UHTCs, according to an embodiment. The system 100 may include a polymer selective laser sintering (SLS) machine 110 and an as-deposited powder bed 120. For indirect processing, a polymer SLS machine 110 may be used. The application of an organic and reactive binder phase lowers the laser energy required to form the initial part geometry and makes this method more accessible than other direct laser powder bed fusion methods for metals or ceramics. In an example, the SLS machine 110 may include a 5 W 808 nm diode laser, X-Y accuracy ≤50 μm, heated build platform, and maximum print size of 110 mm×160 mm×230 mm for used for melting or sintering of comparatively low temperature (polymer) materials. The sealed build chamber may be modified for compatibility with argon (Ar) gas and equipped with a dynamic oxygen (O₂) monitoring device to prevent Ti oxidation during SLS green body shaping.

### Print Geometries and Precursor Rationale

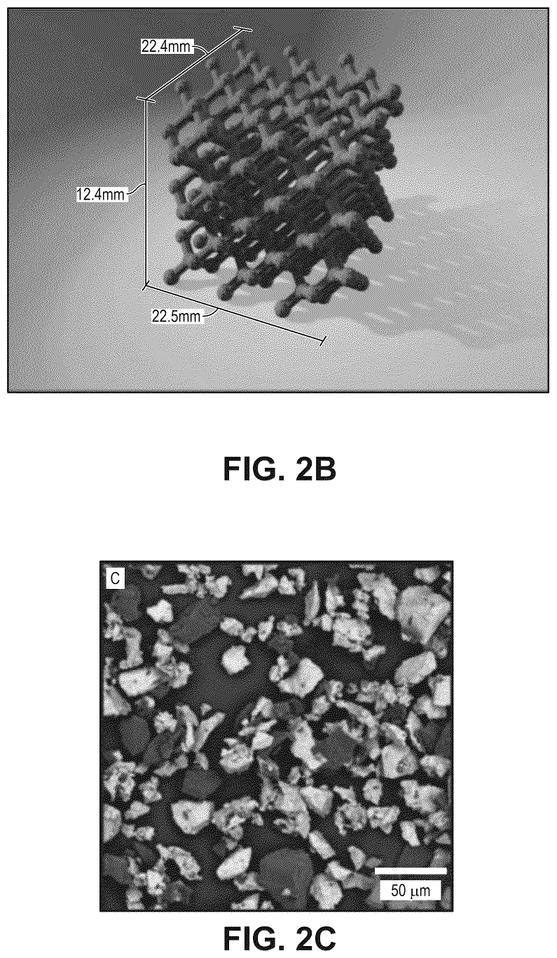

FIGS. 2A-2C illustrate digital illustrations of STL files used for printing the target test structures, according to an embodiment. More particularly, FIG. 2A illustrates a 15 mm×15 mm×15 mm cube, and FIG. 2B illustrates a diamond lattice structure. FIG. 2C illustrates a BSE-SEM micrograph of the 75/25 vol % Ti/phenolic precursor particle morphology, where large bright particles are Ti, and dark particles are phenolic.

Two print geometries were selected for component fabrication: a 1.5 cm×1.5 cm×1.5 cm cube to assess the influence of anisotropic volume changes, part density, and CH₄ penetration; and a complex diamond cubic lattice structure to evaluate the spatial resolution and precision of the AM processing scheme. Other shapes such as bend bars or dog bone tensile/compression test bars may also be fabricated for additional mechanical testing.

The optical power output of the 5 W laser in the PBF machine may be maximized, however varied optical output may be used. The scan speeds of the SLS machine 110 may be fixed and limited to a predetermined threshold (e.g., 100 mm/s). The powder bed build plate may be preheated to a temperature below the melting temperature of the phenolic to reduce typical laser energy requirements (e.g 50° C.). Preliminary trials using Ar processing indicated that the average energy density was too low for direct sintering of Ti particles to occur. Additionally, because of the safety risks associated with reactive laser processing in CH₄ without a discrete gas exhaust line in SLS machine 110, strategies employing in-situ gas-solid reactivity using CH₄ may not be employed. Rather, this indirect processing followed by ex-situ CH₄ conversion of green body parts may be used.

### Ti+Phenolic Resin Precursor Formulation and SLS Processing

Ti powder (e.g., Atlantic Equipment Engineers Ti-107) and phenolic novolac resin (e.g., Hexion Durite AD-5614) may be selected as the feedstock material for laser sintering in Ar and green body shaping. Good flowability may be helpful for powder bed AM processes in which a counter roller is used to deposit thin layers of material. Relatively large particles (e.g., 10-100 μm) may enhance flowability and result in powder-packed densities between 25-45%. Both the Ti powder and phenolic resin were selected due to their <74 μm particle size and morphology which enabled reliable materials screening over the build platform. Durite AD-5614 phenolic, in particular, was selected due to its robust bonding characteristics when cured, high carbon yield (58 wt %), and decomposition temperature (950° C.). A BSE-SEM image showing the mixture of Ti and phenolic particles (75 vol % Ti, 25 vol % phenolics) is shown in FIG. 2C. Since the number of backscattered electrons is proportional to the mean atomic number of the elemental components, bright particles in BSE images are associated with titanium due to its higher average atomic number. The precursor mixtures may be mixed from about 1 hour to about 3 hours in a roller mixer containing ceramic mixing media to ensure homogeneous particle distribution.

Ti may be utilized in the feedstock (e.g., rather than a Ti/TiO₂ composite precursor), so volume expansion upon conversion to TiC (+14.2 vol % for Ti→TiC_{1.0} may largely compensate for consumption of the binder during pyrolysis and reactivity. Initial conversion trials using ˜14.2 vol % phenolic were conducted to test the lower limit for binder content. This was subsequently increased to 25 vol % for further testing to increase the integrity of the green part. For shaping of the green body via SLS, the internal build chamber was set to 50° C. to help reduce residual stresses and pre-heat the phenolic so laser energy can efficiently bring the precursor mixture to the phenolic glass transition temperature. The melting/glass transition temperature of the durite powder is estimated to be approximately 125° C. with curing temperatures occurring at 150° C. (e.g., taking roughly 60 seconds). O₂ levels may be dynamically monitored and reduced to <0.2 vol % O₂ before selective laser sintering using the 5 W 808 nm diode laser. A summary of the processing parameters is presented in Table 1.

TABLE 1
SLS Laser Processing Parameters

| | |
|---|---|
| Materials | 75 vol % Ti + 25 vol % Phenolic |
| SLS Processing Gas | 100 vol. % Ar (8 L/min) |
| Target Product | TiC_{1.0} |
| Wavelength | (λ) = 808 nm |
| Average Power | (P) = 5.0 W |
| Scan Speed | (V) = 100 mm/sec |
| Resolution | (R) = ~50 μm |
| Deposition Layer Thickness | (D_{layer}) = 175 μm |
| Powder Bed Temperature | (T_{Bed}) = 50° C. |

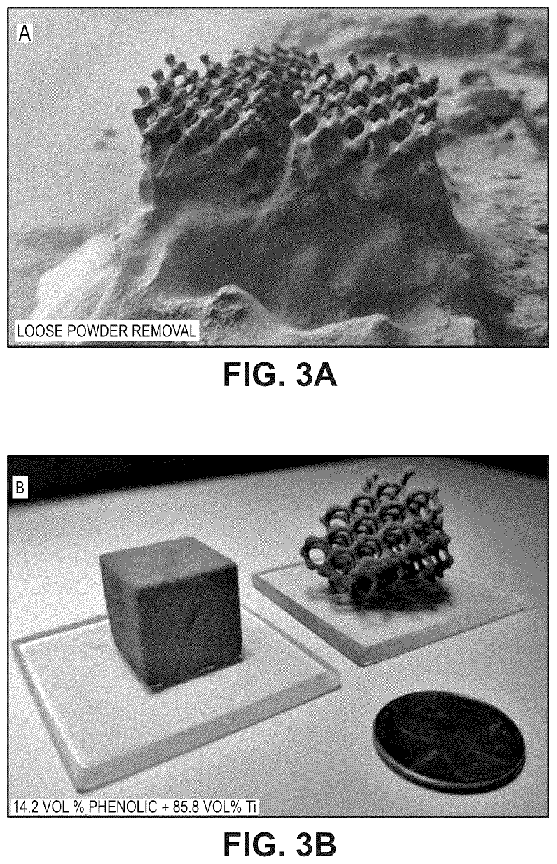

FIGS. 3A and 3B illustrate green bodies formed from 14.2 vol % phenolic resin powder+85.8 vol % Ti, according to an embodiment. More particularly, FIG. 3A shows the components during removal from the powder bed, and FIG. 3B shows the components after loose powder was removed. The structure shown in FIG. 3B had low inter-particle binding leading to damaged features and disintegration of the cube's lattice's corners.

Binder phases (e.g., polyamides, amorphous polystyrene, and polypropylene) used for indirect selective laser processing of ceramics can constitute ˜50-70 vol % of the feedstock. Preliminary tests incorporating 14 vol % phenolic binder produced particles that were very weakly bound in the green body, leaving the shape with similar mechanical characteristics to those of damp sand. This made handling the laser-sintered body impractical and small features prone to damage upon removal from the powder bed, and this is shown by photographs in FIGS. 3A and 3B.

To increase the mechanical properties of the green body, the phenolic resin content may be increased to 75 vol % Ti powder+25 vol % phenolic resin powder, and this composition forms a reliable precursor formulation for ease of handling and robustness. The final composition and characteristics of the precursor material used for two-step TiC AM and reaction synthesis are presented in Table 2. A higher vol % of binder may be used to alter microstructural characteristics and shrinkage in other iterations as required by the specific application.

TABLE 2
Characteristics of Selected Precursor Materials Used for Indirect TiC Formation

| | | Feedstock | Particle | Density | Carbon | Carbonization |
|---|---|---|---|---|---|---|
| | Manuf./Name | Volume | Size | (g/cm³) | Yield | Temp |
| Ti | AEE Ti-107 | 75% | ≤74 | 4.506 | — | — |
| Powder | | | μm | | | |
| Phenolic | Hexion | 25% | ≤74 | ~1.1 | ~58 | 950° C. |
| | Durite AD- | | μm | | wt % | |
| | 5614 | | | | | |

While the volume of the phenolic in this mixture may not be entirely compensated for by Ti carburization, this method may explore the reaction synthesis methods for AM of UHTCs. Compared to the 50-70 vol % of binder materials used in ceramic feedstocks, a reduction ˜25% reduction in binder volume is an improvement that might mitigate excessive shrinkage during post-processing.

### Tube Furnace Post-Processing

Using the composition in Table 3, pyrolysis of the phenolic binder phase may generate enough carbon for 31.3% conversion to stoichiometric TiC_{1.0}. Gas-solid processing in CH₄ may be used to complete the reactivity of the green body to TiC. After SLS, the structures may be post-processed in 80/20 vol % Ar/CH₄ using the tube furnace apparatus. An alumina tube, rather than a quartz tube, may be used to permit higher processing temperatures of up to 1350° C.

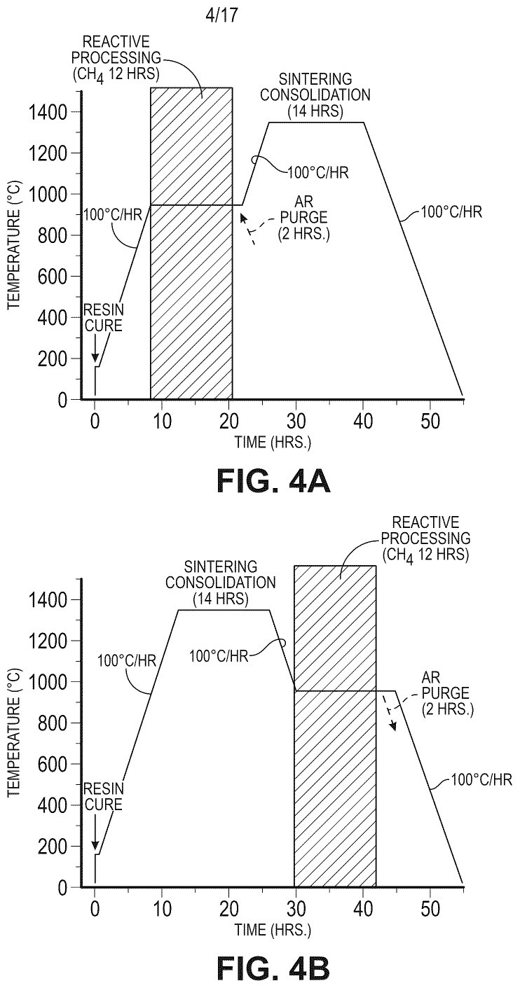

Three conversion regimes using two different heating schedules in either inert or reactive gas may be used for conversion and consolidation. Variations in heating relative to processing to atmospheres may be used to assess the influence of conversion on volume change and carbide yield. An initial dwell time of about 0.5 hrs at about 160° C. may be used to cure the binder phase and lock in the geometric configuration before ramping to peak temperatures. The ramp-up and ramp-down rates after phenolic cross-linking (160° C.) may be fixed at about 100° C./hr. After curing, the temperature may be increased either to 950° C. (for gas-solid conversion, then sintering at 1350° C.) or directly to 1350° C. (for pre-sintering, followed by reaction at 950° C.). Table 3 and FIGS. 4A and 4B illustrate the different post-processing reaction schemes, according to an embodiment. More particularly, FIGS. 4A and 4B illustrate conversion of 75 vol % Ti+25 vol % phenolic green state parts to TiC components.

TABLE 3
Summary of Post-processing Regimes

| | Scheme I: | Scheme II: | Scheme III: |
|---|---|---|---|
| | Inert Processing | React, Post- | Pre-Sinter, |
| | (Control) | Sinter | React |
| Ramp Up Rate | 100° C./hr | 100° C./hr | 100° C./hr |
| (above 160° C.) | | | |
| Ramp Down Rate | 100° C./hr | 100° C./hr | 100° C./hr |
| Dwell 1 | 950° C. | 950° C. | 1350° C. |
| | (Ar) | (CH₄) | (Ar) |
| Dwell 2 | 1350° C. | 1350° C. | 950° C. |
| | (Ar) | (Ar) | (CH₄) |

The rationale behind each set of reaction conditions is summarized as follows:
Scheme I is a control process where samples are heated to 950° C. (the phenolic decomposition and CH₄ reaction temperature) in an inert atmosphere. This is done to estimate the TiCₓ yield from C(s) supplied by phenolic decomposition without gas-solid conversion. After heating and reactive dwell at 950° C., samples were sintered and consolidated at 1350° C.
Scheme II utilizes the same heating schedule as Scheme I but incorporates CH₄ gas-solid reactions to convert unreacted Ti to TiC during the 950° C. dwell. After gas-solid conversion, the sample is sintered at 1350° C. to aid consolidation.
Scheme III incorporates both C(s) and CH₄ reactivity, however, the sample is first sintered at 1350° C. to understand how the brown part density (the green body after sintering) affects CH₄ gas-penetration, conversion to low stoichiometry TiCₓ prior that might impact reaction bonding and part volume change.

In each case, the total time during each segment of the heating schedule is substantially identical. Phenolic may occur efficiently between about 950-1000° C. A reaction temperature of 950° C. for gas-solid reaction with CH₄ may be used to mitigate carbon deposition that was observed at higher temperatures. The total flow rate may be maintained at about 250 SCCM during heating in inert (e.g., 100 vol % Ar) or reactive (e.g., 80/20 vol % Ar/CH₄) atmospheres. For samples that are processed in reactive atmospheres, CH₄ may be introduced into the furnace at the 950° C. dwell temperature for a dwell time of 14 hrs. The introduction of CH₄ at the peak dwell temperature may be selected to maximize the ΔGᵣ and facilitate reaction bonding between particles without spontaneous gas-phase CH₄ decomposition and carbon nucleation that might otherwise clog porosity and inhibit conversion. Due to the slow decomposition of phenolic and slow solid-state carbon reactivity for carbide compared to gas conversion, CH₄ reactivity may be dominant in the conversion process. Factors such as ramp rates, peak temperature, dwell time, processing sequence, and/or gas composition may influence the carbide product obtained, total volume change, and residual porosity of the product. Such properties may be intentionally tailored to the requirements of the desired additively manufactured part.

### Characterization

SLS processed and converted materials may be characterized using x-ray diffraction (XRD) to determine the rate of conversion to TiCₓ. Quantitative phase characterization may be performed from 20° to 80° 2θ using Rietveld refinement. XRD may be conducted on cube sample surfaces and on cross-sections. Surface characterization provided phase composition data when gas-solid reactivity was not limited by CH₄ diffusion through the inter-particle matrix. XRD of the cross-section may be used to estimate the average conversion achieved through the ˜15 mm sample thickness. A combination of optical and SEM microscopy methods may be used to characterize the sample microstructures.

### Results

### Recovery and Morphology of Green Bodies

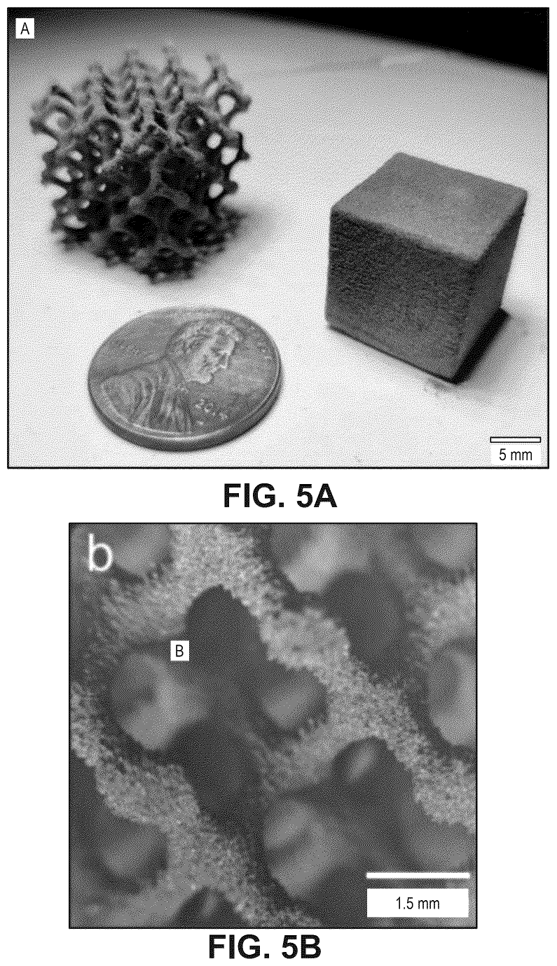

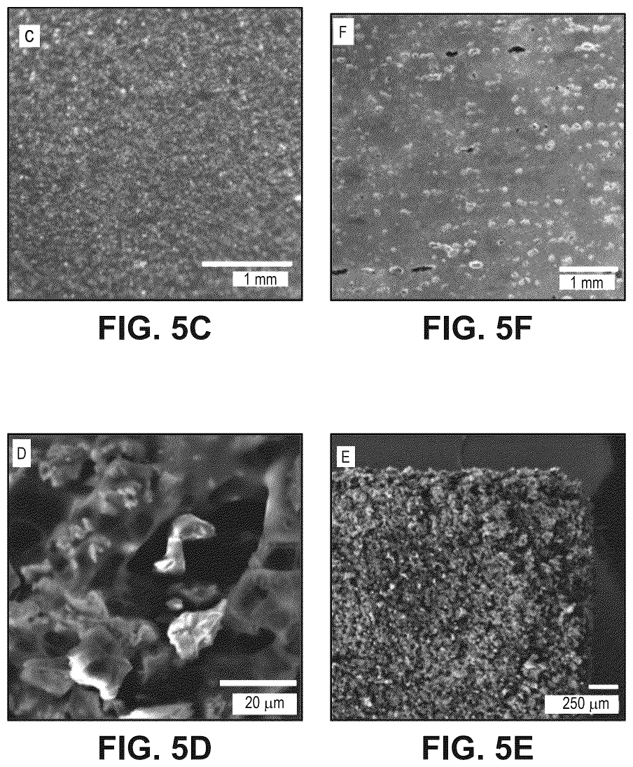

SLS-processed, titanium green bodies may be removed from the build chamber, handled, and separated from loose particles without notable damage to either the cube or the fine lattice structures. Once removed from the build plate, they may be inspected using optical microscopy. FIGS. 5A-5F illustrate the morphology of the Ti/phenolic lattice 510 and cube 520, according to an embodiment. More particularly, FIG. 5A illustrates a photograph of the 75 vol % Ti powder+25 vol % phenolic resin (92.5/7.5 wt %) SLS processed into the diamond lattice 510 and the cube 520. FIGS. 5B, 5C, and 5E illustrate photomicrographs of the surface roughness and resolution of the printed structures. FIG. 5D illustrates the Ti particles bound in melted phenolic after SLS processing. FIG. 5F illustrates a polished cross-section of the epoxy impregnated green body.

The average as-printed dimensional variations from the specified 15 mm×15 mm×15 mm cube 520 are 0.0%, −0.7%, and +2.7% in the x, y, and z directions respectively for five samples. The larger deviation in the z-direction may be due to the selection of layer deposition height parameter (175 μm) and rough Ti particle morphology that does not optimally pack. Such values can be compensated for using the AM software. The unreacted, as-printed density of the green bodies was determined to be ˜31.8% dense. This value falls within the 25-45% range. An increase in green body density may also be achieved through optimization of particle packing using spherical particles, a bi-modal distribution of particles, or alternative slurry-like deposition approaches.

### Conversion Propensity and Phase Analysis Following Post Processing in CH₄

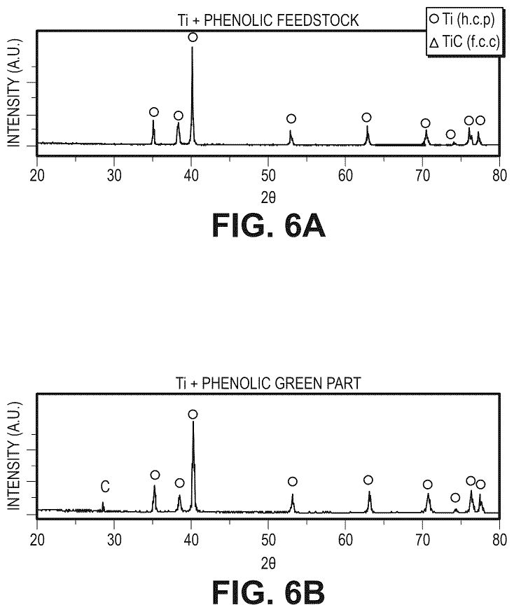

FIGS. 6A and 6B illustrate XRD spectra of the unreacted precursor materials and the green-state sample, according to an embodiment. More particularly, FIG. 6A illustrates XRD spectra of unreacted 75 vol % Ti powder+25 vol % phenolic resin feedstock, and FIG. 6B illustrates the green-state sample after SLS processing.

XRD characterization of Ti+phenolic precursor in FIG. 6A indicates primary peaks associated with α-Ti. Meanwhile, the amorphous structure of the phenolic resin may not result in a defined diffraction pattern. Phenolic resins may display broad amorphous humps from 5-25 degrees 2θ. SLS processing of the 75 vol % Ti powder+25 vol % phenolic may induce partial decomposition of the phenolic binder (as indicated by the C peak at 28 degrees 2θ), but not in-situ carbide formation SLS, as shown in FIG. 6B. Therefore, conversion to TiCₓ may involve ex-situ furnace post-processing.

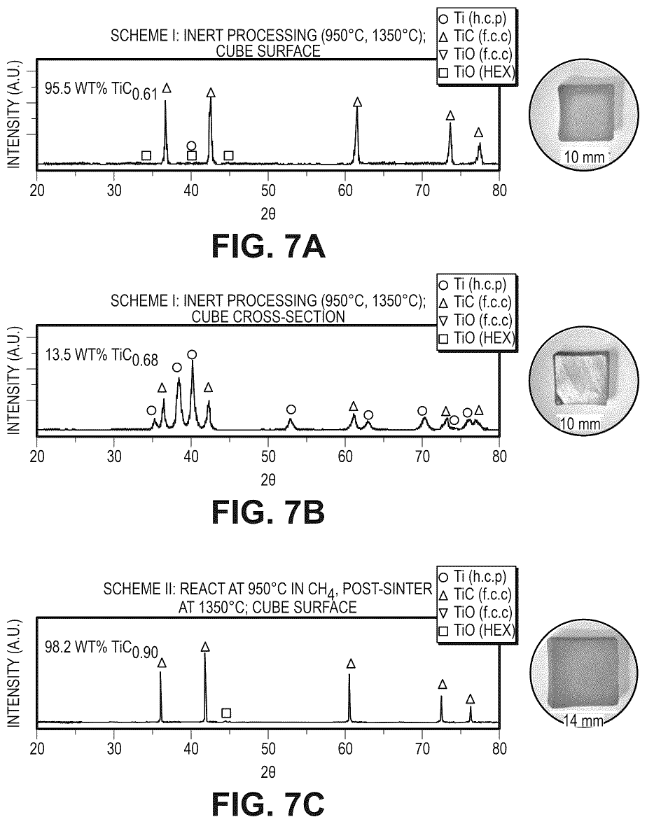

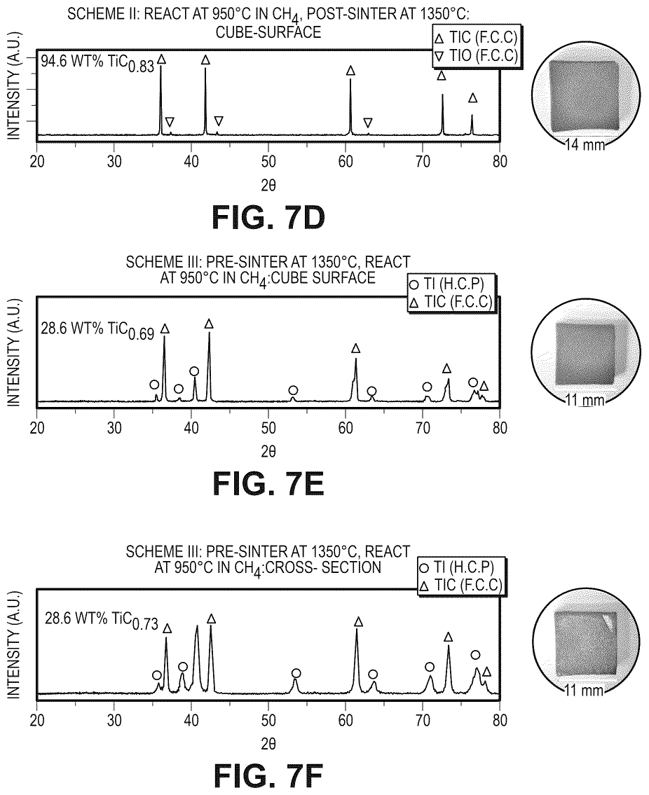

Post-processing was performed according to the heating schedules and gas composition presented in Table 3 and FIGS. 4A and 4B. FIGS. 7A-7F illustrate XRD results obtained on the converted cube surface and on the cube cross-section, according to an embodiment. More particularly, FIGS. 7A-7F illustrate XRD spectra of post-processed Ti+phenolic parts converted to TiCₓ. For each processing scheme, the optical images of the characterized sample surfaces and cross-sections are shown.

The TiCₓ yield obtained from cube surface characterization is reflective of the maximum carbide yield when gas-phase availability is not limited. Phase characterization of the cube cross-section (in the x,z plane along the gas flow direction and perpendicular to the alumina substrate) is representative of the average chemical composition. Conversion results are summarized in Table 4.

TABLE 4
X-Ray Composition Analysis of Post-Processed Ti + Phenolic Cubes Using Rietveld Refinement Modeling

| | | Total | | | Unr. | Calc. | |
|---|---|---|---|---|---|---|---|
| | | Titanium | | | Ti | Volume | |
| | | Carbide | TiCₓ, | Calc. NaCl- | (wt %) | Change for | |
| Characterization | Characterization | TiCₓ | Lattice | Type | or | conversion | |
| Area | Area | Product | Parameter | Product | C in | of Ti to | |
| (Cube) | (Cube) | (wt %) | (Å) | Stoichiometry | α-Ti | TiCₓ^{†} | Notes |
| Scheme I: | Surface | 95.5% | 4.289 | TiC_{0.61} | <1% | 11.30% | Trace TiO (hex) |
| Inert | | | | | | | phase at 44.2° 2θ |
| Processing | | | | | | | (<2.4 wt %) and |
| (Control) | | | | | | | TiO (cubic) |
| | Cross- | 13.5% | 4.300 | TiC_{0.68} | 86.5% | 3.32% | Lack of |
| | Section | | | | | | reflection for β- |
| | | | | | | | Ti at 44.7° |
| | | | | | | | despite large |
| | | | | | | | peak at 38.4°. |
| | | | | | | | The lattice |
| | | | | | | | parameter of α- |
| | | | | | | | Ti: a = 2.963 Å, |
| | | | | | | | c = 4.717 Å; |
| | | | | | | | suggests carbon |
| | | | | | | | incorporation in |
| | | | | | | | the lattice. |
| Scheme II: | Surface | 98.2% | 4.322 | TiC_{0.90} | 0% | 14.14% | Trace TiO (hex) |
| React, | | | | | | | phase at 44.2° 2θ |
| Post- | | | | | | | (<1.8 wt %) |
| Sinter | Cross- | 94.6% | 4.317 | TiC_{0.83} | 0% | 13.10% | TiO (fcc) phase |
| | Section | | | | | | at 37.2° amd |
| | | | | | | | 43.4° 2θ (<5.4 |
| | | | | | | | wt %) |
| Scheme III: | Surface | 81.5% | 4.301 | TiC_{0.69} | 18.5% | 10.90% | Unknown trace |
| Pre- | | | | | | | impurity at 2.2° |
| Sinter, | | | | | | | and 44.2° 2θ |
| React | Cross- | 38.6% | 4.306 | TiC_{0.73} | 61.4% | 6.47% | The lattice |
| | Section | | | | | | parameter of α- |
| | | | | | | | Ti: a = 2.953 Å, |
| | | | | | | | c = 4.710 Å; |
| | | | | | | | suggests carbon |
| | | | | | | | incorporation in |
| | | | | | | | the lattice. |

Conversion at 950° C. in 80/20 vol Ar/CH₄ resulted in up to 98.2 wt % TiC_{0.90} yield from the 75 vol % Ti powder+25 vol % phenolic precursor mixture. Diffraction peaks at 36.0°, 41.8°, 60.6° 2θ in FIGS. 7A-7F are indicative of NaCl-type TiCₓ ceramic. NaCl-type TiCₓ has a wide range of stoichiometries and interstitial carbon occupancies that range from TiC_{0.47}—TiC_{1.0}. Using Rietveld refinement, the lattice parameters of the TiCₓ product phases may be estimated to range from 4.289-4.322 Å. These values can be compared to the lattice parameter of 4.327 Å for stoichiometric TiC_{1.0}. Quantitative assessment using empirically derived lattice parameter-chemistry relationships indicates that the product carbide stoichiometry varied between TiC_{0.61}—Ti_{0.90} and was highly dependent on processing parameters.

Using control scheme I, surface conversion of the Ti+phenolic cube may be achieved (95.5 wt %, TiC_{0.61}) without CH₄ gas reactivity. The carbide phase in the cube's cross-section was determined to be 13.5 wt % TiC_{0.69} with a visually metallic inner core. In the absence of CH₄ gas-solid reactivity, carbonaceous compounds appeared to migrate to the exterior of the cube (and possibly exit the structure) before phenolic decomposition was complete. This was partially indicated by carbonized resin traces observed on the interior of the alumina tube after processing. By contrast, α-Ti and/or a solid solution of C and α-Ti was the dominant unreacted phase in the interior of the inert processed sample. If carbon from phenolic decomposition was completely consumed during the solid-state reaction, the estimated yield of TiC_{0.61} may be approximately 51 wt %, assuming sample homogeneity. The conversion results indicate that the utilization of carbon supplied by phenolic binder was only ˜26% efficient.

XRD analysis indicates that the addition of CH₄ to the post-processing atmosphere dramatically increased TiCₓ yield. The direct reaction of Ti and C(s) may involve higher temperatures than are needed for reactions with CH₄ which can rapidly occur at temperatures near 700° C. Post-processing of the Ti+phenolic structures using scheme II produced 98.2% surface TiC_{0.90} and 95.1 wt % average TiC_{0.83}. No unreacted Ti precursor material was detected by XRD. TiO (at 37.2° and 43.3° 2θ in FIGS. 7A-7F) was the only other quantifiable trace component (<5.4 wt %). Oxygen contamination in the interior of the structure rather than on the top cube surface might be related to preferential oxidation of Ti particles by off-gassing phenolic decomposition products and more incomplete reduction in the interior of the sample with limited CH₄ gas-phase availability. Even so, results in Table 4 suggest that when structures were subject to gas-solid reactivity before high-temperature sintering at 1350° C., the reaction was almost complete. The product composition, TiC_{0.83}, is very near the non-stoichiometric composition (TiC_{0.78±0.03}) with the maximum melting temperature of 3070° C. which far greater than the processing temperatures used.

In contrast to scheme II, conversion via scheme III (i.e., pre-sintering followed by CH₄ reactivity) hindered gas-phase reactivity and appeared to prevent CH₄ penetration into the sintered particle mixture. The exterior of the sample was converted to 81.1 wt % TiC_{0.69}, while the interior sample composition was 38.6 wt % TiC_{0.73} with α-Ti remaining as the primary unconverted phase. The melting temperature of Ti is approximately 1668° C. so initial heating at 1350° C. densifies the green body by thermal sintering—this occurs optimally between ⅔-¾ Mₚ or 1100-1250° C. for Ti. The larger lattice parameter of α-Ti that was determined by Rietveld refinement (a=2.953 Å, c=4.671 Å, compared to 2.951 Å and =4.686 Å) suggests solubility of carbon in the h.c.p. titanium lattice. The total integrated time during heating for the reactive processing schemes was identical at 54.8 hrs. However, the time of gas-solid reactivity within the overall processing timeline appears to dictate conversion efficiency and resultant volume change.

### Volume Change and Morphological Assessment of Converted AM Structures

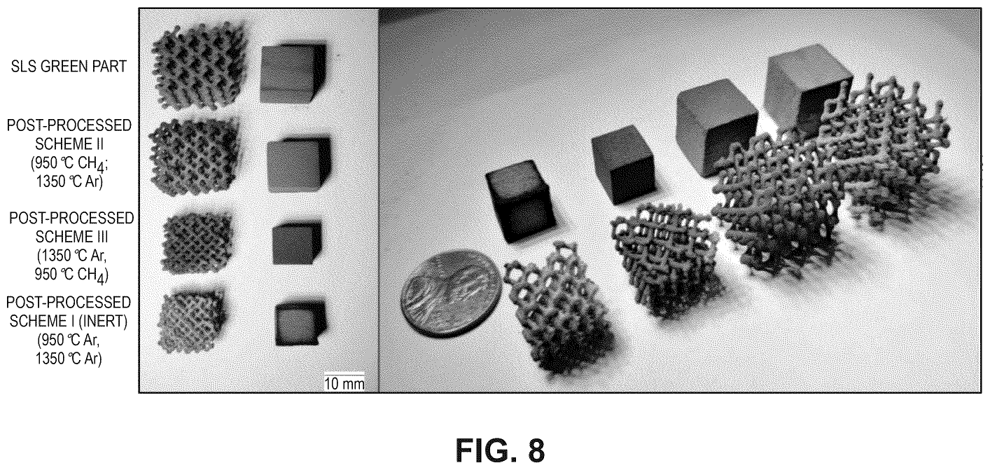

After de-binding, conversion, and consolidation, the AM cube and lattice structures may be measured to estimate the net volume changes associated with gas-solid conversion, densification, and sintering. The dimension and mass/density changes of the samples are summarized in Table 5. A comparison between the cube and lattice samples before and after furnace processing is shown in FIG. 8.

| | | | | | | | | Estimated |
|---|---|---|---|---|---|---|---|---|
| | | X | Y | Z | Volume | Mass | Density | Volumetric |
| | Composition | (mm) | (mm) | (mm) | (cm³) | (g) | (g/cm³) | Occupancy |
| SLS Cube | α-Ti + | 15.00 | 14.90 | 15.41 | 3.445 | 4.01 | 1.16 | 31.8% |
| (Green) | Phenolic | (SD = 0.08) | (SD = 0.06) | (SD = 0.06) | (SD = 0.05) | (SD = 0.01) | (SD = | (SD = 0.003) |
| | | | | | | | 0.01) | |
| Cube | TiC_{0.68} | 10.50 | 10.41 | 10.43 | 1.140 | 3.91 | 3.44 | 73.8% |
| (Scheme | (13.5 | | | | | | | |
| I, Inert) | wt %) | | | | | | | |
| | α-Ti (86.5 | — | — | — | — | — | — | — |
| | wt %) | | | | | | | |
| % | — | −30.0% | −30.1% | −32.3% | −66.9% | −2.55% | +197% | +42.0% |
| Change, | | — | — | — | — | — | — | — |
| Inert | | | | | | | | |
| Cube | TiC_{0.93} | 14.17 | 14.00 | 14.36 | 2.847 | 4.34 | 1.52 | 31.8% |
| (Scheme | (94.6 | (SD = 0.07) | (SD = 0.06) | (SD = 0.03) | (SD = 0.007) | (SD = 0.005) | (SD = | (SD = 0.01%) |
| II: 950° C., | wt %) | | | | | | 0.002) | |
| 1350° C.) | | | | | | | | |
| % Change | — | −5.56% | −6.04% | −6.81% | −17.32% | +8.10% | +30.7.% | 0.0% |
| | | (SD = 0.42%) | (SD = 0.41%) | (SD = 0.41%) | (SD = 0.22%) | (SD = 0.12%) | (SD = | (SD = 0.04%) |
| | | | | | | | 1.21%) | |
| Cube | TiC_{0.69} | 10.90 | 10.72 | 10.96 | 1.281 | 3.91 | 3.06 | 52.3% |
| (Scheme | (38.6 | | | | | | | |
| III: | wt %) | | | | | | | |
| 1350° C., | α-Ti (61.4 | (SD = 0.02) | (SD = 0.01) | (SD = 0.02) | (SD = 0.01) | (SD = 0.005) | (SD = | (SD = 0.04%) |
| 950° C.) | wt %) | | | | | | 0.001) | |
| % Change | — | −27.33% | −28.05% | −28.88% | −68.82% | −2.49% | +162% | −20.5% |
| | | (SD = 0.13%) | (SD = 0.07%) | (SD = 0.13%) | (SD = 0.17%) | (SD = 0%) | (SD = | (SD = 0.04%) |
| | | | | | | | 1.20%) | |

Relatively uniform shrinkage of cube samples occurred across the x, y, and z from post-processing (Table 5). Increased consolidation in the z-direction may be due to gravity. The volumetric occupancy and porosity of the green samples were nearly identical using scheme II, but not scheme I (inert) or scheme III (sinter, then react). When reactivity preceded conversion, the high melting point of the TiCₓ product phase (up to 3160° C.) prevented significant densification due to slow atomic diffusion. While stoichiometric TiC_{1.0} was not achieved, a comparison of the results for samples processed in scheme II and III suggests temperature control and heating duration can be used to alter green body microstructures and tailor conversion rates and carbide stoichiometry. This two-step post-processing procedure may be efficient in creating dense, and robust UHTC components if gas-solid reactivity is carried out before the green body is densified until gas diffusivity is limited. During this reaction synthesis process, temperature, gas composition and processing conditions may be controlled to ensure simultaneous exothermic reactivity, reaction bonding, and densification to produce well-bonded, denser TiC parts. Through proper selection of post-processing times and temperatures, gas and carbon diffusion may be controlled to meet the length scales required for component features (e.g., thin lattice struts versus a dense cube). Additionally, post-processing techniques such as isostatic pressing may be used to tailor and/or increase the density of the final part.

Volume expansion from the conversion of Ti→TiC_{1.0} used up to ˜42% of the phenolic volume contained in the green body. This effect may be beneficial compared to non-reactive methods, but the high shrinkage inherent to multi-step AM processes may not be wholly circumvented. Non-reactive SLS methods that incorporate 50-70 vol % organic binder materials are subject to anisotropic shrinkage (−36.8 vol % to −61.4 vol %), cracking, and low part densities ranging from 36-66%. These values are comparable to those presented in this work when reactivity was incomplete, and the brown body was α-Ti rich (i.e., 66.9% to 68.8% volume reduction). Using scheme II, the combination of the chemically-induced volume changes and slow atomic diffusion for TiCₓ reduced shrinkage to −17.3% where interparticle bonding was achieved by gas-solid reactivity. In this case, the volumetric occupancy of 31.8% was unchanged and substantially identical to the green body. This indicates qualitatively that expansion from Ti to TiCₓ partially reduced overall consolidation due to phenolic burnout. Higher-temperature post-sintering (not accessible in this work) and or isostatic pressing could then be used after reactivity to increase density at the expense of some part shrinkage. The combination of these factors can be tailored for the requirements of the desired application. This method (in comparison to direct densification of non-reactive particle-based UHTC green bodies) may reduce defect structures generally observed for indirect UHTC AM. Samples using this two-step reactive approach were physically robust enough to be handled and macroscopically crack-free.

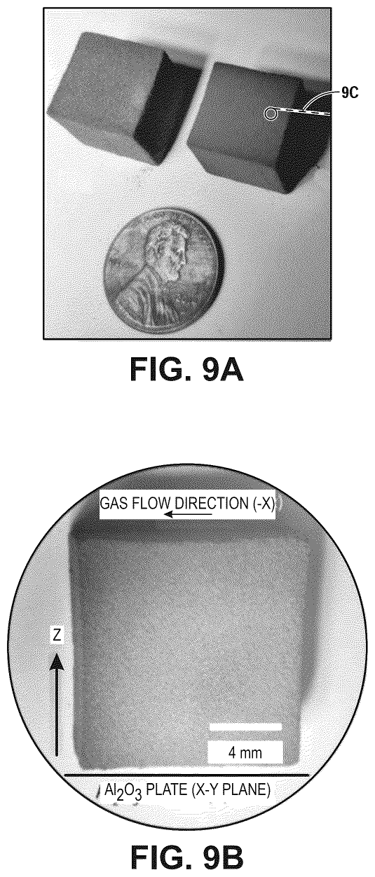

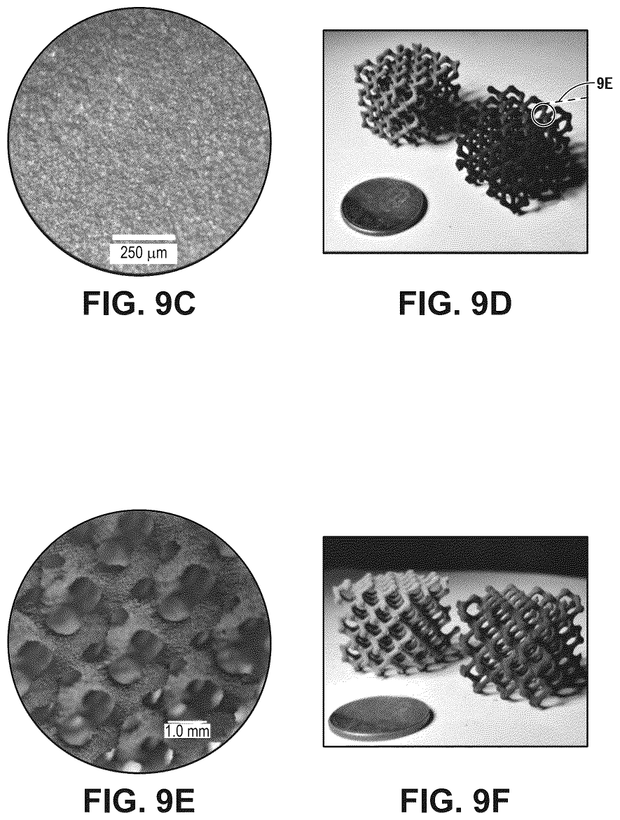

FIGS. 9A-9F illustrate photographs and photomicrographs depicting the SLS processed green Ti+phenolic cube samples before and after CH₄ post-processing to TiCₓ, according to an embodiment. More particularly, FIG. 9A illustrates the green state cube on the left, where the cube on the right shows the cube following reactive post-processing in CH₄ that was converted to TiCₓ. FIG. 9B illustrates the cross-section of the post-processed structure showing uniform conversion into the center of the structure under the prevailing reaction conditions. FIG. 9C illustrates the surface morphology of the TiCₓ cube. In FIGS. 9D and 9F, the leftmost sample is the unreacted green Ti+phenolic lattice, while the rightmost sample is the TiCₓ material after post-processing. FIG. 9E illustrates a high magnification image of the lattice morphology after CH₄ post-processing.

### Observations on the Volume Changes for Lattice Structures

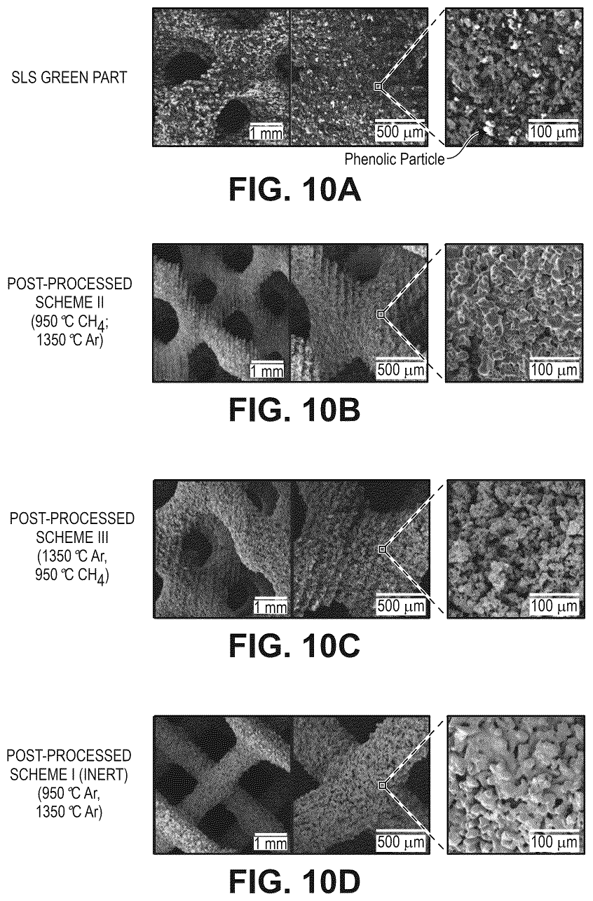

FIGS. 10A-10D illustrate SEM images of lattice structures, according to an embodiment. FIG. 10A illustrates the structures prior to post-processing, and FIGS. 10B-10D illustrate the structures after post-processing. The samples are presented in order of descending macroscopic lattice size, as in FIGS. 9A-9F.

Similar shrinkage relationships were observed for lattice structure structures as for the cubes for processed using schemes I-III. The composition of these samples was not explicitly characterized via XRD. The stoichiometry and wt % fractions of TiCₓ are assumed to be greater than or equal to the cubes given their higher surface area to volume ratios and shorter distances for diffusion. Two differences in the volume change response during brown body formation and subsequent sintering were observed:
1. Close inspection of FIGS. 10A-10D reveals that the cross-sectional diameter of struts disproportionately consolidated due to the high surface area to volume and aspect ratios of the features compared to the overall lattice dimensions.
2. Consolidation in the z-direction (compared to the x or y directions) was more significant with the smaller feature sizes of the lattice especially when the materials composition α-Ti rich.
   These effects have been noted by others in non-reactive ceramics-AM processing schemes that require high-temperature sintering/consolidation. Anisotropic and geometry-dependent volume changes may be considered during the digital design of green bodies to obtain the required final geometry.

TABLE 5
Summary of SLS Processed Lattice Samples Pre- and Post-conversion in CH₄ to TiC

| | | | | | Boundary | |
|---|---|---|---|---|---|---|
| | | X | Y | Z | Volume | Mass |
| Sample | Composition | (mm) | (mm) | (mm) | (cm³) | (g) |
| SLS Lattice | α-Ti + | 22.06 | 22.05 | 22.72 | 11.05 | 1.58 |
| (Green) | Phenolic | (SD = 0.13) | (SD = 0.20) | (SD = 0.08) | (SD = 0.14) | (SD = 0.02) |
| Lattice | TiCₓ | 16.01 | 15.93 | 14.43 | 9.83 | 1.46 |
| (Scheme I, | | | | | | |
| Inert) | | | | | | |
| % Change, | | −27.4% | −28.6% | −36.5% | −67.2% | −6.3% |
| Inert | | | | | | |
| Cube | TiCₓ | 20.99 | 21.62 | 21.67 | 9.83 | 1.74 |
| (Scheme II: | | | | | | |
| 950° C., | | | | | | |
| 1350° C.) | | | | | | |
| % Change | — | −4.9% | −2.0% | −4.6% | −11.0% | +9.78% |
| Cube | TiCₓ | 17.68 | 17.36 | 14.82 | 4.55 | 1.48 |
| (Scheme III: | | | | | | |
| 1350° C., | | | | | | |
| 950° C.) | | | | | | |
| % Change | | −19.9% | −22.3% | −34.8% | −60.2% | −4.4% |

### Gibbs Free Energy and TiCₓ Stoichiometry

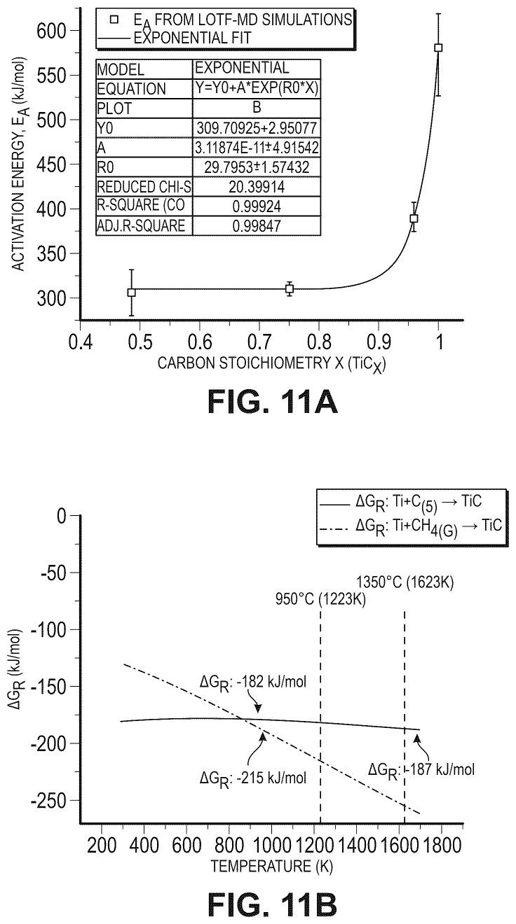

FIGS. 11A and 11B illustrate graphs showing the influence of carbon stoichiometry in TiCₓ on activation energy is required for C diffusion (FIG. 11A) and the temperature-dependent ΔGᵣ associated with Ti reaction with Cₛ or CH₄ (FIG. 11B), according to an embodiment. Molecular dynamics simulations for C diffusivity in TiCₓ, revealed that as carbon stoichiometry increases, the activation energy for diffusion may also increase. Processing conditions are therefore intrinsically related to the carbide phases formed and reaction bonding behavior. The exponential relationship relating NaCl-type TiCₓ stoichiometry (TiC_{0.47}—TiC_{1.0}) and activation energy for interlattice C diffusion is shown in FIG. 11A. Activation engines may increase rapidly above TiC_{0.9} and support experimental results where samples processed in CH₄ achieved a maximum interstitial occupancy of 0.83 (0.90 on the surface) after 12 hrs of reactive processing, after which energy requirements make stoichiometric conversion difficult to achieve.

Reaction thermodynamics are presented in FIG. 11B where ΔGᵣ is plotted as a function of temperature for conversion of Ti by Cₛ or CH₄. Thermodynamic calculations suggest that the exothermic reaction,

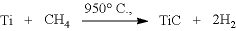

is more thermodynamically favorable (ΔG°ᵣ=−215 kJ/mol) than the reactivity of Ti with Cₛ,

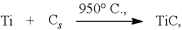

(ΔG°ᵣ=−182 kJ/mol) after phenolic decomposition. By relating thermodynamic and kinetic data to processing conditions, differences in gas-solid versus solid-state reactivity are shown to impact the surface microstructure and propensity for particle bonding to occur. SEM image microscopy in FIGS. 11A and 11B illustrates those lattices subject to isothermal conversion in CH₄ before sintering at 1350° C. (scheme II) had diffusion and/or reaction bonding that formed a continuous network of TiCₓ. Due to the high melting point of TiCₓ (Mₚ˜3000° C.) relative to the post-processing temperature 1350° C., sintering of the reacted structure can be largely excluded from the primary bonding mechanism. Here, the ΔG°ᵣ=−215 kJ/mol release may have facilitated rapid exothermic reaction propagation and reaction bonding through surface diffusion. The interparticle bonding observed from initial isothermal gas-solid conversion (even when conducted without heating at 1350° C.) was as significant as bonding induced from sintering of the Ti structure (Mₚ: 1668° C.) when processed using identical but inert conditions (scheme I). These results contrast the surface morphology of the structure obtained by post-processing using scheme III, where particles appear discretely converted (FIGS. 11A and 11B). Although reactivity-induced free energy release (in the experimental temperature range 25-1350° C.) may not singularly overcome activation energies required for carbon diffusion through TiC_{0.47}—TiC_{1.0}, ΔG°ᵣ can facilitate C diffusion through α-Ti (Eₐ=91 kJ/mol) or aid self-diffusion of Ti containing dilute carbon (Eₐ=126 kJ/mol). Without isothermal gas-phase reactivity, carbide conversion may be rate-limited by the decomposition of phenolic resin and conversion through slow solid-state carbothermal reactions. This process may hinder conditions that can produce large releases in free energy, where increases local temperature from exothermic reactions can drive interparticle adhesion of refractory UHTCs.

The additional driving force for diffusion may enhance interparticle bonding compared to other indirect AM techniques where gas-solid reactivity does not occur. For example, slow heating rates of ˜6° C./hr may be used for tube furnace de-binding of green bodies composed of non-reactive refractory ceramics particles, otherwise particle bonding does not significantly occur. Rates above 6° C./hr with similar levels of porosity may not have any appreciable mechanical characteristics and readily crumbled. Even with these slow heating rates, the formation of robust SiC parts required molten Si infiltration to prevent disintegration and crack formation from post-processing. In this work, a heating rate of 100° C./hr was used without any significant structural defects. Even samples fabricated in preliminary trials that relied solely on 950° C. reaction synthesis (8 hrs dwell, no 1350° C. sintering) were robust enough to be easily handled, macroscopically defect-free, and nearly fully converted to carbide. Without reactivity, the higher melting point of TiC (compared to SiC) might prevent robust refractory carbide parts from being obtained using standard indirect SLS methodologies when processing temperatures are well below what is ordinarily required for UHTC sintering (T>2000° C.).

### High-Temperature Testing of TiCₓ Lattice

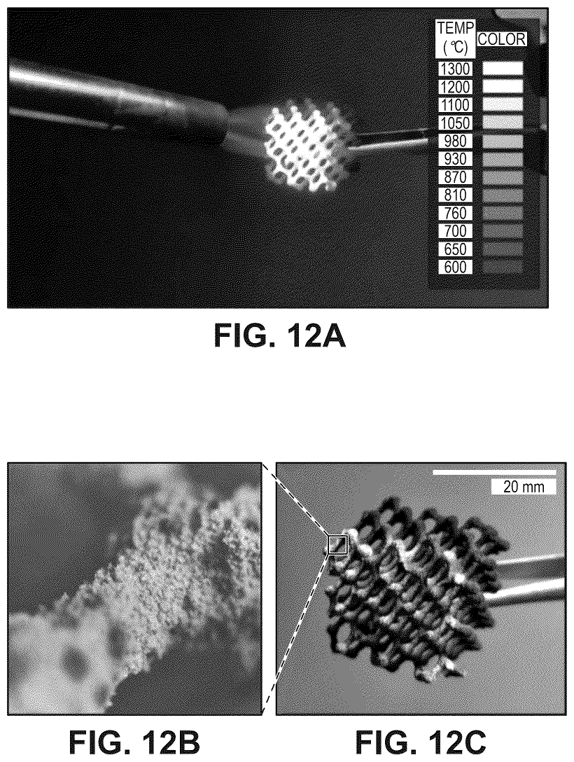

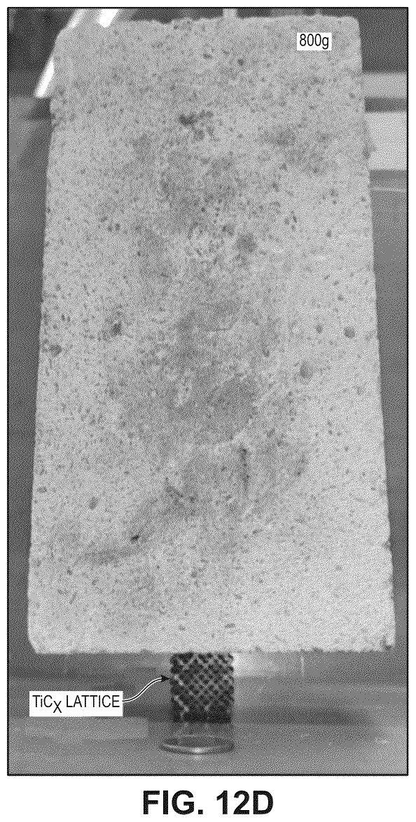

FIG. 12A illustrates a photograph from a blow torch test, FIG. 12B illustrates an optical micrograph of the resulting microstructure, FIG. 12C illustrates a photograph of the product lattice, and FIG. 12D illustrates the lattice after heating supporting an 800 g alumina firebrick to illustrate its qualitative mechanical properties, according to an embodiment. A penny is shown for scale in FIG. 12D.

Lattice structures fabricated using the two-step AM process may be thermally stressed using continuous propane torch heating to demonstrate their refectory characteristics and resistance to thermal shock. The lattice produced using scheme II may be used for testing because it contains the greatest phase fraction TiCₓ and the highest theoretical melting temperature due to its ˜TiC_{>0.83} stoichiometry. This sample may be positioned approximately 25 mm from the end of the propane blow torch. Once lit, the lattice may be subject to about 120 seconds of continuous heating using the hottest portion of the blue inner flame cone. The air-fed propane torch is estimated to produce flame temperatures of approximately 1300° C.

The flame-facing surface of the lattice reached the torch's peak temperature according to a qualitative estimate based on its black body radiation. A digital pyrometer was initially used but it reached its maximum operational reading of 1190° C. and was unable to provide temperatures beyond this upper limit. For high-temperature applications (e.g., hypersonics, atmospheric re-entry), the thermal properties for transition metal carbide materials are specific heat and thermal conductivity. The surface properties include emissivity and surface roughness while density and coefficient of thermal expansion (CTE) are relevant bulk properties. The AM lattice manufactured using the two-step approach exhibits a unique combination of such characteristics due to its TiCₓ materials composition:
1. High molar heat capacity that increases with temperature, 50.5 J mol⁻¹ K⁻¹ at 25° C., 53.8 J mol⁻¹ K⁻¹ at 1000° C. (TiCₓ);
2. Low-moderate thermal conductivity that decreases with temperature from 17.4 W m⁻¹ K⁻¹ at 25° C. to 5.24 W/m/k to 1000° C. and declines with carbon deficiency;
3. High emissivity (˜0.9); and/or
4. Low CTE that is porosity independent (5.2-7.4×10⁻⁶ K⁻¹).

The demonstration shown in FIG. 12A suggests that this combination of properties makes the lattice produced using a highly efficient “thermal soak” and/or high-temperature catalyst due to its high surface area to volume ratio. The lattice did not experience a mechanical failure or cracking due to TiCₓ's low coefficient of thermal expansion (CTE), residual porosity, and reaction bonded structure. Blackbody temperature estimation suggests that the front of the lattice reached a peak temperature of 1300° C. within 3.5 seconds of heating. Despite the small dimensions of the lattice, the back half of the structure reached thermal equilibrium at ˜600° C., while still being enveloped in the propane flame. This temperature differential correlates to the temperature gradient ˜320° C. per linear cm in the 20.99 mm×21.62 mm×21.67 mm TiCₓ structure. As the material was heated, high heat capacity and low thermal conductivity may prevent heat transfer before the heat is promptly re-emitted due to high emissivity. The effects of high surface area may be improved by the macroscopic and microscopic porosity the TiC_{0.83} structure which is only about 3.7% of the occupied lattice volume. Similar architected porous transition metal carbide structures may be of relevance to catalytic and thermal management applications, where unique structures and high surface area to volume rations facilitate reactivity or cooling.

Even after thermal shock testing, FIG. 12D indicates the AM lattice structure qualitatively maintained qualitatively useful mechanical properties and was able to support an 800 g alumina firebrick. The culmination of these properties makes AM structures produced in this work of interest for further investigation and development of unique refractory components.

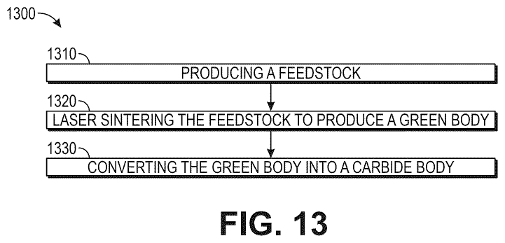

FIG. 13 illustrates a flowchart for a method 1300 of for AM of UHTCs, according to an embodiment. An illustrative order of the method 1300 is provided below; however, one or more steps of the method 1300 may be performed in a different order, combined, split into sub-steps, repeated or omitted.

The method 1300 may include producing a feedstock, as at 1310. The feedstock may include a metallic powder and a binder material. The metallic powder may be or include from about 50% to about 95%, about 60% to about 90%, about 70% to about 80%, or about 75% of the feedstock (by weight or volume), and the binder material may be or include from about 5% to about 50%, about 10% to about 40%, about 20% to about 30%, or about 25% of the feedstock. The metallic powder may be or include hafnium, zirconium, tantalum, titanium, or a combination thereof. The binder material may be or include a phenolic resin.

The method 1300 may also include laser sintering the feedstock to produce a green body, as at 1320. More particularly, the feedstock may be laser sintered in the selective laser sintering (SLS) machine designed for either metals or polymers 110 in the presence of an inert and/or noble gas such as argon. The green body may be or include a cube, a lattice, or a combination thereof. Other shapes and/or structures are also contemplated herein.

The method 1300 may also include converting the green body into a transition metal carbide body, as at 1330. More particularly, this may include an ex-situ isothermal gas-solid conversion that takes place in the tube furnace 120 in the presence of methane. The conversion may occur at a temperature from about 700° C. to about 1200° C., about 800° C. to about 1100° C., about 900° C. to about 1000° C., or about 950° C. The conversion may occur for a time from about 0.1 hrs to about 48 hrs. The carbidization reaction(s) that govern the conversion are described in Equations 1 and 2 above. The net dimensional volume change of the part from the conversion of the green body to the final carbide may be from 0 vol % to 80 vol %, where the porosity of the carbide microstructure may be from 0 vol % to 95 vol % as determined by the selection of precursor ratio and ex-situ processing parameters. The UHTC or transition metal carbide part may be or include a TiC lattice.

### CONCLUSIONS

The two-step in reactive AM approach may be used to form the UHTC, TiCₓ. Equipment such as the polymer powder bed fusion AM machine 110 and tube furnace 120 may be used to produce complex UHTC parts. This processing scheme incorporated, (1) selective laser sintering of Ti precursor mixed with a phenolic binder for green body shaping, and (2) ex-situ, isothermal gas-solid conversion of the green body in CH₄ to form a TiCₓ part. Three different heating schedules were investigated for efficient reactivity and volume control of the green 15 mm×15 mm×15 mm cubes (scheme I: inert gas processing; scheme II: gas-solid reactivity then post-sintering; scheme III: pre-sintering then gas-solid reactivity). The results indicate that phenolic decomposition during post-processing facilitated a cross-sectional TiC_{0.68} yield of 13.5 wt %. Meanwhile, the reactive processing in CH₄ may be effective in promoting conversion to TiCₓ of varied carbide stoichiometries. A maximum yield of 98.2 wt % TiC_{0.90} (94.6 wt % TiC_{0.83} interior) was achieved when samples were first converted in 80/20 Ar/CH₄ at 950° C. then sintered at 1350° C. in Ar. When heating and reactivity were carried out in reverse order, higher cube volumetric occupancies but more shrinkage (−68.8% vs −17.3%) were induced due to pre-sintering of Ti before UHTC formation. With the complete conversion of Ti to TiCₓ, molar volume expansion (+14.2%) appears to partially compensate for phenolic binder decomposition and the densification process for reduced component shrinkage as compared to non-reactive indirect SLS processing. Reaction kinetics (carbon diffusion through TiCₓ) and Gibbs free energy release appear to control the product stoichiometry and reaction bonding behavior that enables carbide particles to bond during low-temperature processing that is otherwise unachievable. Processing characteristics and the precursor ratio of binder to transition metal may dictate the final porosity and volume of the part.

Complex lattice geometries may also be fabricated using this AM methodology to investigate the utility of the reactive AM approach in producing intricate structures with small features (<800 μm struts, ˜50 μm resolution). For the post-processing schemes, resulting lattices may be robust enough to be handled and crack-free. The TiC_{>0.83} lattice produced using scheme II was subjected to rapid, high-temperature heating to characterize the materials' response to extreme thermal loads. The unique combination of TiC_{>0.83} materials properties and the complex AM structure allowed the lattice to reach a peak steady-state temperature of 1300° C. for 2 minutes with minimal oxidation and without fracture. If denser UHTC components are desired, higher-temperature post-sintering and/or isostatic pressing may be used after reactivity to increase density. This method (in comparison to direct densification of non-reactive particle-based UHTC green bodies) may reduce defect structures generally observed for indirect UHTC AM. Broadly, with additional development and investigation, this additive manufacturing approach may be viable for the production of UHTC carbides such as ZrC, HfC, or TaC that are otherwise incompatible with prevailing AM techniques which do not incorporate reaction synthesis techniques.

As used herein, the terms “inner” and “outer”; “up” and “down”; “upper” and “lower”; “upward” and “downward”; “upstream” and “downstream”; “above” and “below”; “inward” and “outward”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.”

Although the present disclosure has been described in connection with preferred embodiments thereof, it will be appreciated by those skilled in the art that additions, deletions, modifications, and substitutions not specifically described may be made without departing from the spirit and scope of the disclosure as defined in the appended claims.

1. A method for additive manufacturing (AM) a carbide body, the method comprising:
producing a feedstock comprising a metallic powder and a binder material;
laser sintering the feedstock in a laser sintering machine in a presence of an inert gas to produce a green body; and
converting the green body into the carbide body in a furnace in a presence of a flowing alkane gas.

2. The method of claim 1, wherein the metallic powder comprises hafnium, zirconium, tantalum, titanium, chromium, iron, vandium, niobium, cobalt, nickel, molybdenum, tungsten, or a combination thereof, and wherein the binder material comprises an organic resin.

3. The method of claim 1, wherein the metallic powder comprises from about 50 wt % to about 95 wt % of the feedstock, and wherein the binder material comprises from about 5 wt % to about 50 wt % of the feedstock.

4. The method of claim 1, wherein the metallic powder comprises particles having an average diameter ranging from about 5 pam to about 100 μm.

5. The method of claim 1, wherein the feedstock is laser sintered to above a melting point of the binder material but below a melting point of the metallic powder.

6. The method of claim 1, wherein the conversion comprises an ex-situ isothermal gas-solid conversion.

7. The method of claim 1, wherein the alkane gas comprises methane having a flowrate from about 5 SCCM to about 10 L/min, and wherein the alkane gas has a composition from about 1 vol % to about 100 vol %.

8. The method of claim 1, wherein the conversation takes place at a temperature from about 700° C. to about 1200° C. for a duration from about 0.1 hours to about 20 hours.

9. The method of claim 1, wherein the carbide body comprises a refractory transition metal carbide body.

10. The method of claim 1, wherein the carbide body comprises an ultra-high-temperature ceramic (UHTC) body.

11. A method for additive manufacturing (AM) an ultra-high-temperature ceramic (UHTC) body or transition metal carbide body, the method comprising:
producing a feedstock, wherein the feedstock comprises a metallic powder and a binder material, wherein the metallic powder comprises from about 60 wt % to about 90 wt % of the feedstock, wherein the metallic powder comprises particles having an average diameter ranging from about 10 m to about 1000 pam, wherein the binder material comprises from about 10 wt % to about 40 wt % of the feedstock, and wherein the binder material comprises a resin;
laser sintering the feedstock to produce a green body, wherein the feedstock is laser sintered in a laser sintering machine in a presence of an inert gas, and wherein the feedstock is laser sintered to above a melting point of the binder material but below a melting point of the metallic powder; and
converting the green body into the UHTC body or transition metal carbide body, wherein the conversion comprises an ex-situ isothermal gas-solid conversion, wherein the conversion takes place in a furnace in a presence of a flowing alkane gas, wherein the alkane gas has a flowrate from about 10 SCCM to about 5 L/min, wherein the alkane gas has a composition from about 5 vol % to about 100 vol %, and wherein the conversation takes place at a temperature from about 800° C. to about 1100° C. for a duration from about 0.5 hours to about 15 hours.

12. The method of claim 11, wherein the metallic powder comprises a transition metal, and wherein the inert gas comprises argon, nitrogen, or both.

13. The method of claim 11, wherein the green body comprises a plurality of deposited layers of the feedstock, and wherein each deposited layer has a height from about 10 μm to about 250 μm.

14. The method of claim 11, wherein a net dimensional volume change from the conversion of the green body into the UHTC body or transition metal carbide body is from 0 vol % to 80 vol %.

15. The method of claim 11, wherein a porosity of the UHTC body or transition metal carbide body is from 0 vol % to 95 vol %.

16. A method for additive manufacturing (AM) an ultra-high-temperature ceramic (UHTC) body, the method comprising:
producing a feedstock, wherein the feedstock comprises a metallic powder and a binder material, wherein the metallic powder comprises from about 65 wt % to about 85 wt % of the feedstock, wherein the metallic powder comprises a transition metal, wherein the metallic powder comprises particles having an average diameter ranging from about 20 μm to about 60 μm, wherein the binder material comprises from about 15 wt % to about 35 wt % of the feedstock, and wherein the binder material comprises a resin;
laser sintering the feedstock to produce a green body, wherein the feedstock is laser sintered in a laser sintering machine in a presence of an inert gas, wherein the inert gas comprises argon, nitrogen, or both, wherein the feedstock is laser sintered with a scan speed from about 1 mm/s to about 10 m/s, wherein the feedstock is laser sintered to above a melting point of the binder material but below a melting point of the metallic powder, wherein the green body comprises a plurality of deposited layers of the feedstock, and wherein each deposited layer has a height from about 10 μm to about 250 μm; and
converting the green body into the UHTC body, wherein the conversion comprises an ex-situ isothermal gas-solid conversion, wherein the conversion takes place in a furnace in a presence of a flowing methane, wherein the methane has a flowrate from about 50 SCCM to about 10 L/min, wherein the methane has a composition from about 10 vol % to about 100 vol %, and wherein the conversation takes place at a temperature from about 900° C. to about 1000° C. for a duration from about 1 hour to about 10 hours.

17. The method of claim 16, wherein the transition metal comprises hafnium, zirconium, tantalum, titanium, chromium, iron, vandium, niobium, cobalt, nickel, molybdenum, tungsten, or a combination thereof, wherein the resin comprises a phenolic resin, a carbonaceous resin, or both, wherein the green body comprises a cube, a lattice, or both, and wherein the UHTC body comprises a metallic carbide lattice.

18. The method of claim 16, wherein a net dimensional volume change from the conversion of the green body into the UHTC body is from 0 vol % to 80 vol %.

19. The method of claim 16, wherein a porosity of the UHTC body is from 0 vol % to 95 vol %.

20. The method of claim 16, further comprising varying the composition, the temperature, the duration, or a combination thereof to cause a volume of the UHTC body, a stoichiometry of the UHTC body, a chemistry of the UHTC body, a porosity of the UHTC body, or a combination thereof to vary.
